(19) United States
(12) Patent Application Publication
(10) Pub. No.: US 2013/0311946 A1
(43) Pub. Date: Nov. 21, 2013

(54) APPARATUS AND METHOD FOR USER-CENTERED ICON LAYOUT ON MAIN SCREEN

(71) Applicant: O-Hyeong KWON, Seoul (KR)

(72) Inventor: O-Hyeong KWON, Seoul (KR)

(21) Appl. No.: 13/890,553

(22) Filed: May 9, 2013

(30) Foreign Application Priority Data
May 17, 2012 (KR) 10-2012-0052387

(51) Int. Cl. G06F 3/0481

(52) U.S. Cl. CPC G06F 3/04817
USPC 715/811

(57) ABSTRACT

Disclosed herein is an apparatus for user-centered icon layout on a main screen. The apparatus includes a generator which analyzes a usage pattern of a user terminal according to applications and generates lifestyle information based on a user preference of the applications, a determiner which determines order of priority with regard to the applications according to usage frequency and duration for each of the applications installed in the user terminal based on the lifestyle information, and a display which selects N applications (where, N is a natural number) based on the determined order of priority with regard to the applications, loads icons respectively corresponding to the N selected applications from a memory, and displays the icons on the main screen of the user terminal.

### CROSS-REFERENCE TO RELATED APPLICATION

This application claims priority to Korean Patent Application No. 10-2012-0052387 filed on 17 May, 2012, and all the benefits accruing therefrom under 35 U.S.C. §119, the contents of which is incorporated by reference in its entirety.

### BACKGROUND

1. Technical Field

Embodiments of the invention generally relate to a screen layout, and more particularly, to an apparatus and method for user-centered icon layout on a main screen.

2. Description of the Related Art

Generally, a user interface (UX-UI: user experience-user interface) screen such as a menu screen or a standby screen of a portable terminal such as a mobile communication terminal and the like is previously programmed with a pop-up menu or an icon menu. Thus, a user of the portable terminal cannot change the layout or icons of the menu as needed. That is, a typical portable terminal allows a user to set up a user interface such as a menu screen or the like within a range set by a terminal manufacturer.

In a general portable terminal, a menu screen shows only the same previously defined menu items and a menu or the like cannot be reconstituted according to a user's requests even though each user uses menu items with different frequencies. However, a user interface (UX-UI) is a very important factor for mobile terminals or computing devices.

In an existing method, polygonal icons are regularly or irregularly arranged on a polygonal display, such as square or circular shaped displays, such that a user can select a desired icon to execute a certain program. Such an existing method is inconvenient when positioning a large number of icons given limited screen real estate, which requires changing between screens to use different sets of icons.

Therefore, there is increasing need for development of a user interface excellent in convenience and accessibility to an application.

### BRIEF SUMMARY

It is an aspect of the present invention to provide an apparatus and method for user-centered icon layout on a main screen, in which the icons on the main screen are displayed as a user-centered three-dimensional (3D) UX-UI by taking a user preference of using an application into account, thereby improving user convenience and accessibility to the application that a user prefers or frequently uses.

The present invention is not limited to this aspect, and other aspects, objects, features and advantages of the invention will become apparent to those skilled in the art from the following description.

In accordance with one aspect of the invention, an apparatus for user-centered icon layout on a main screen includes: a generator which analyzes a usage pattern of a user terminal according to applications and generates lifestyle information based on a user preference of the applications; a determiner which determines order of priority with regard to the applications according to usage frequency and duration for each of the applications installed in the user terminal based on the lifestyle information; and a display which selects N applications (where, N is a natural number) based on the determined order of priority with regard to the applications, loads icons respectively corresponding to the N selected applications from a memory, and displays the icons on the main screen of the user terminal.

The apparatus may further include an application recommender which records and updates a use pattern of an application used more frequently than a preset number of times for a preset duration by operation of the icons displayed on the main screen, determines a recommendation index of an application based on an updated result, and makes a recommendation list of applications based on the recommendation index, wherein the display displays the recommendation list on the main screen of the user terminal.

The apparatus may further include a schedule recommender generating an update package in which a user's life pattern is reflected through analysis of the lifestyle information, and recommending a schedule related to use of an application based on the generated update package.

The schedule recommender may estimate a current prediction issue based on news, newspapers, or issues in the same time of day as that of the past related to weather, and recommend the schedule based on the prediction issue.

The display may arrange N icons loaded from the memory in the form of a three-dimensional (3D) sphere consisting of plural folds of transparent layers, and display the icons as an integrated user interface (UI) on the main screen of the user terminal.

The display may display the N icons on the main screen of the user terminal such that icons of respective layers are sequentially exposed to a superficial layer of the main screen according to schedules of applications determined corresponding to months, dates, days of a week, and time of day. Here, the exposed icon is displayed again on the integrated UI at the next schedule after the exposed icon disappears from the integrated UI.

In accordance with another aspect of the present invention, a method for user-centered icon layout on a main screen includes: by a generator of an apparatus for user-centered icon layout on the main screen, analyzing a usage pattern of a user terminal according to applications, and generating lifestyle information based on a user preference of the applications; by a determiner of the apparatus for user-centered icon layout, determining order of priority with regard to the applications according to usage frequency and duration for each of the applications installed in the user terminal based on the generated lifestyle information; and by a display of the apparatus for user-centered icon layout, selecting N applications (where, N is a natural number) based on the determined order of priority with regard to the applications, loading icons respectively corresponding to the N selected applications from a memory, and displaying the icons on the main screen of the user terminal.

The method may further includes: by an application recommender of the apparatus for user-centered icon layout, recording and updating a use pattern of an application used more frequently than a preset number of times for a preset duration by operation of the icons displayed on the main screen of the user terminal; by the application recommender of the apparatus for user-centered icon layout, determining a recommendation index of an application based on the updated result; by the application recommender of the apparatus for user-centered icon layout, making a recommendation list of applications based on the determined recommendation index; and by the display of the apparatus for user-centered icon layout, displaying the recommendation list on the main screen of the user terminal.

The method may further include: by a schedule recommender of the apparatus for user-centered icon layout, generating an update package in which a user's life pattern is reflected through analysis of the lifestyle information; and recommending a schedule related to use of an application based on the generated update package.

The method may further include: by the schedule recommender of the apparatus for user-centered icon layout, estimating a current prediction issue based on news, newspapers, or issues in the same time of day as that of the past related to weather; and by the schedule recommender of the apparatus for user-centered icon layout, recommending the schedule based on the prediction issue.

The method may further include: by the display of the apparatus for user-centered icon layout, arranging N icons loaded from the memory in the form of a three-dimensional (3D) sphere consisting of plural folds of transparent layers, and displaying the icons as an integrated user interface (UI) on the main screen of the user terminal.

The method may further include: by the display of the apparatus for user-centered icon layout, displaying the N icons on the main screen of the user terminal such that icons of respective layers are sequentially exposed to a superficial layer of the main screen according to schedules of applications determined corresponding to months, dates, days of a week, and time of day, the exposed icon being displayed again in the integrated UI at the next schedule after the exposed icon disappears from the integrated UI.

According to embodiments of the present invention, icons are displayed in the form of a user-centered 3D UX-UI on the main screen based on a user preference of an application, thereby improving convenience and accessibility to the application that a user prefers or frequently uses.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 is a block diagram explaining an apparatus for user-centered icon layout on a main screen according to one embodiment of the present invention;

FIG. 2 illustrates an example where a 3D UX-UI of a main screen is achieved, according to one embodiment of the present invention;

FIG. 3 is a flowchart of a method for user-centered icon layout on a main screen according to an embodiment of the present invention;

FIG. 4 is a flowchart of a process of recommending and displaying an application on the main screen according to one embodiment of the present invention; and

FIG. 5 is a flowchart of a process of recommending a schedule related to use of an application according to one embodiment of the present invention.

### DETAILED DESCRIPTION

Hereinafter, embodiments of the present invention will be described with reference to accompanying drawings. It should be understood that the present invention is not limited to the following embodiments and may be embodied in different ways, and that the embodiments are provided for complete disclosure and thorough understanding of the present invention by those skilled in the art. The scope of the invention is defined only by the claims. The same components will be denoted by the same reference numerals throughout the specification and the drawings.

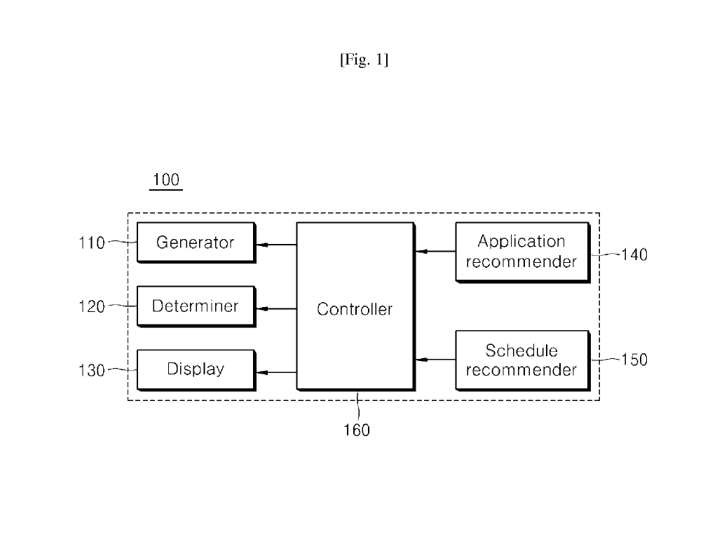

FIG. 1 is a block diagram explaining an apparatus for user-centered icon layout on a main screen according to one embodiment of the present invention.

Referring to FIG. 1, an apparatus 100 for user-centered icon layout on a main screen according to one embodiment includes a generator 110, a determiner 120, a display 130, an application recommender 140, a schedule recommender 150, and a controller 160.

The generator 110 analyzes a usage pattern of a user terminal according to applications, and generates lifestyle information based on a user preference of the applications. Here, it will be appreciated that the lifestyle information includes application information, usage frequency and duration for each application, etc.

In addition, the user terminal may include a stationary communication terminal such as a desktop personal computer (PC) or a mobile communication terminal. The mobile communication terminal may include a mobile device having a communication function, such as a personal digital cellular (PDC) phone, a personal communication service (PCS) phone, a personal handy-phone system (PHS) phone, a code-division multiple access (CDMA)-2000 (1X, 3X) phone, a wideband CDMA (WCDMA) phone, a dual band/dual mode phone, a global standard for mobile (GSM) phone, a mobile broadband system (MBS) phone, a digital multimedia broadcasting (DMB) phone, a smartphone, a cellular phone, etc.

Further, the mobile communication terminal may include all kinds of handheld wireless communication devices, such as public switched telephone network (PSTN) terminals, portable terminals, such as voice over Internet protocol (VoIP), session initiation protocol (SIP), media gateway control protocol (MGCP), media gateway control (MEGACO), personal digital assistant (PDA) terminals, hand-held PCs, notebook computers, laptop computers, WiBro terminals, MP3 players, MD players and the like, international mobile telecommunication (IMT)-2000 terminals offering international roaming service and extended mobile communication service, universal mobile telecommunication service (UMTS)-based terminals, etc.

The portable electronic device such as the portable device and the handheld based wireless communication device may include a predetermined communication module, such as a CDMA module, a Bluetooth module, an infrared data association module, a wired/wireless local area network (LAN) card, and a wireless communication device with a global positioning system (GPS) chip for tracking location through GPS, and may include a microprocessor for reproducing multimedia. Thus, the portable electronic device may be interpreted as a terminal for performing certain operations.

The determiner 120 determines order of priority with regard to the applications according to usage frequency and duration for each of the applications installed in the user terminal based on the lifestyle information. The determiner 120 may determine grades (top/medium/low) of the applications instead of the order of priority with regard to the applications.

The display 130 selects N applications (where, N is a natural number) based on the determined order of priority with regard to the applications, loads icons respectively corresponding to the N selected applications from a memory, and displays the icons on the main screen of the user terminal.

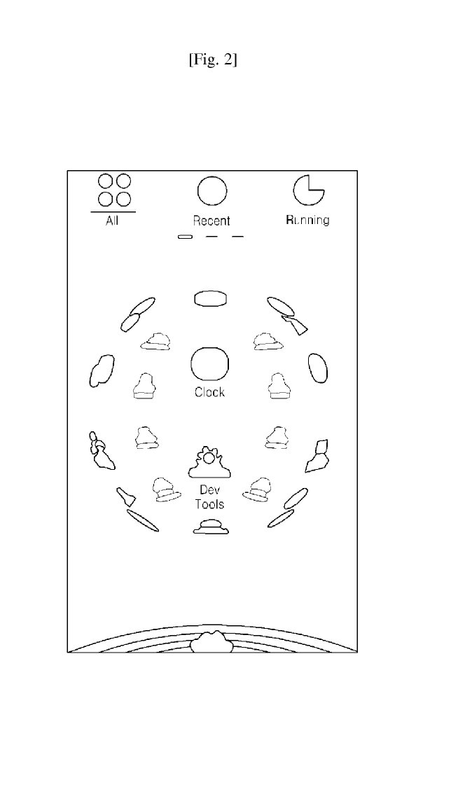

The display 130 may arrange N icons loaded from the memory in the form of a three-dimensional (3D) sphere consisting of plural folds of transparent layers, as shown in FIG. 2, and display the icons as an integrated user interface (UI) on the main screen of the user terminal.

The display 130 may display the N icons on the main screen of the user terminal such that icons of the respective layers are sequentially exposed to a superficial layer of the main screen according to schedules of applications determined corresponding to months, dates, days of a week, and time of day. Here, the display 130 may display the exposed icon again in the integrated UI at the next schedule after the exposed icon disappears from the integrated UI.

The application recommender 140 records and updates a use pattern of an application used more frequently than a preset number of times for a preset duration by operation of the icons displayed on the main screen of the user terminal.

The application recommender 140 may determine a recommendation index of an application based on the updated result. The application recommender 140 may make a recommendation list of applications based on the determined recommendation index. Thus, the display 130 may display the recommendation list on the main screen of the user terminal.

The application recommender 140 infers a user's life pattern from GPS information of the user terminal, time information of obtaining the GPS information, and log information related to use of an application. The application recommender 140 may recommend an application according to positions and time based on the inferred life pattern.

Here, the GPS information may be obtained by the GPS module installed in the user terminal, and the time information may be obtained by a date/time application installed in the user terminal. In addition, the log information may include a name of an application, a use date and time, etc. of when each application is used (executed). Such log information may be recorded in the memory of the user terminal, and loaded from the memory in response to a call from the application recommender 140.

The schedule recommender 150 may generate an update package in which a user's life pattern is reflected through analysis of the lifestyle information. The schedule recommender 150 may recommend a schedule related to use of an application based on the generated update package.

For example, the schedule recommender 150 may estimate a current prediction issue based on news, newspapers, or issues in the same time of day as that of the past related to weather. Further, the schedule recommender 150 may recommend a schedule related to use of an application based on the prediction issue.

The controller 160 may control general operations of the apparatus 100 according to the embodiment, that is, the generator 110, the determiner 120, the display 130, the application recommender 140, the schedule recommender 150, etc.

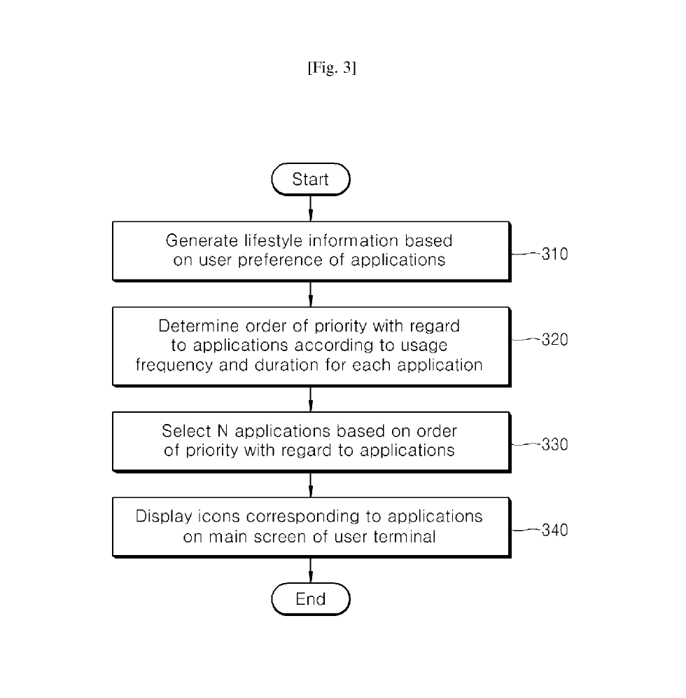

FIG. 3 is a flowchart of a method for user-centered icon layout on a main screen according to one embodiment of the present invention.

Referring to FIGS. 1 and 3, in operation 310, the generator 110 of the apparatus 100 according to the embodiment analyzes a usage pattern of a user terminal according to applications, and generates lifestyle information based on a user preference of the applications.

Next, in operation 320, the determiner 120 of the apparatus 100 determines order of priority with regard to the applications according to usage frequency and duration for each of the applications installed in the user terminal based on the generated lifestyle information.

Next, in operation 330, the display 130 of the apparatus 100 selects N applications based on the determined order of priority with regard to the applications.

Next, in operation 340, the display 130 of the apparatus 100 loads icons respectively corresponding to the N selected applications from the memory and displays the icons on the main screen of the user terminal.

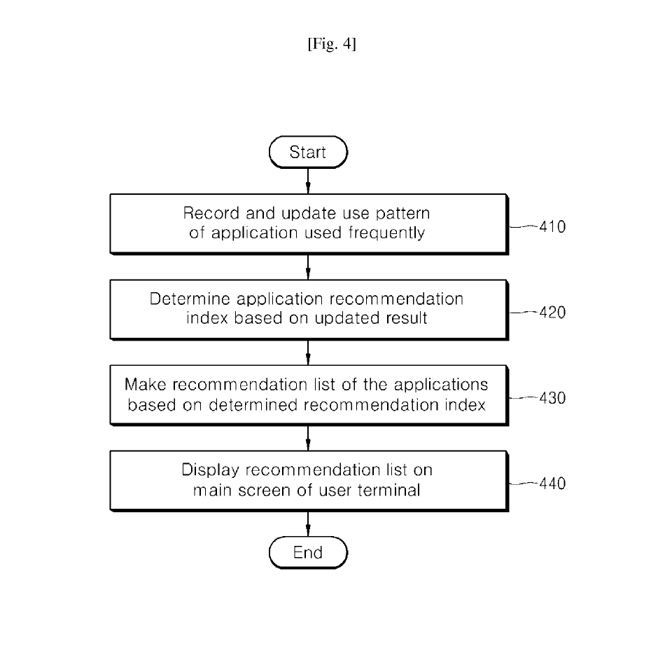

FIG. 4 is a flowchart of a process of recommending and displaying an application on the main screen according to one embodiment of the present invention.

Referring to FIGS. 1 and 4, in operation 410, the application recommender 140 of the apparatus 100 records and updates a use pattern of an application used more frequently than a preset number of times for a preset duration by operation of the icons displayed on the main screen of the user terminal.

Next, in operation 420, the application recommender 140 of the apparatus 100 determines a recommendation index of an application based on the updated result.

Next, in operation 430, the application recommender 140 of the apparatus 100 makes a recommendation list of applications based on the determined recommendation index.

Next, in operation 440, the display 130 of the apparatus 100 displays the recommendation list on the main screen of the user terminal.

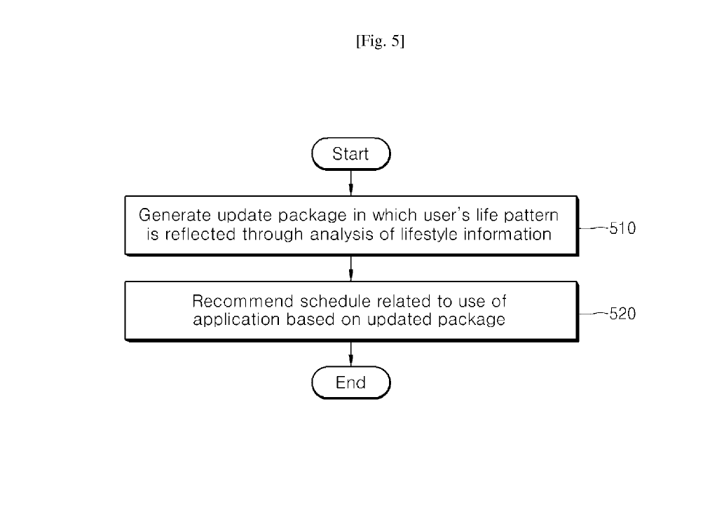

FIG. 5 is a flowchart of a process of recommending a schedule related to use of an application according to one embodiment of the present invention.

Referring to FIGS. 1 and 5, in operation S510, the schedule recommender 150 of the apparatus 100 generates an update package in which a user's life pattern is reflected through analysis of the lifestyle information.

Next, in operation 520, the schedule recommender 150 recommends a schedule related to use of an application based on the generated update package.

Below, an apparatus and method for user-centered icon layout on a main screen according to one embodiment of the present invention will be described in more detail with regard to functional aspects.

The apparatus and method for user-centered icon layout on a main screen according to the embodiment is to realize a 3D menu icon UX-UI. To this end, the following functions may be provided.

### 1. User Customized Function (Lifestyle+Life Time)

An adaptive function for applications based on lifestyle and time schedules according to various individual preferences, such as reading a newspaper in the morning, checking bus location, checking traffic conditions before, searching related to business at office, web surfing or news searching, checking bus location at leaving the office, checking traffic, searching an appointment place and restaurant after work, managing and searching a schedule, managing and searching a schedule for weekend shopping, sports, an outing, etc., which shows a proper program icon to an individual according to the life pattern and time of day.

### 2. User-Centered Updating Function

user-centered UX-UI having updating effect

recording, updating and developing a program (application) menu that a user frequently uses according to a user life pattern or in a certain time of day, or that has been used on a special date (e.g., a memorial day) or in a special time of day.

### 3. User Application Recommendation Function

A UX-UI function of retrieving and recommending applications, which are similar to a use pattern, opposite to the use pattern, popular, being used by many users and prevalent, through artificial intelligence according to a user's certain pattern based on the updating function, while displaying a 3D UX-UI according to use patterns, replacing the icon being displayed on the screen with the recommended application, or displaying the recommended application around the icon, thereby recommending use of the retrieved application to a user.

### 4. User Schedule Recommendation Function

A schedule recommendation function of recommending a new similar, analogous or different schedule, a new travel destination, a new exercise routine, a new restaurant, a new location, a new friend to a user based on a update package, in which a use pattern is reflected through analysis at a certain day or special date according to the updated use pattern, thus adapting a new corresponding schedule to the updated user's schedule.

### 5. Previous Retrieving Recommendation Function

A UX-UI function of estimating a current prediction issue, news, newspaper, weather, etc., based on the issues of the same time of day as that of the past with respect to a new issue of news, newspaper or weather, recommending a previously retrieved schedule to a user, and displaying it on the screen, in addition to the updating function based on the updated use pattern.

### 6. Other Functions

UI transmission through a beam projector

UI operation by a hologram

operation in 3D

shifting or selection of 3D UI through recognition of a user's eye

gradually exposing an inner icon menu layer to become a superficial layer over time, in which the UI having a 3D sphere shape is transparent and has a plurality of folds like an onion

setting up the UI where categories are changed in turn by rotating the UI having the sphere shape up and down instead of left and right

setting up the UI where inner icon menu layers sequentially come out or go in by rotating the UI having the sphere shape up and down instead of rotating it left and right

selecting another sphere through enlargement or reduction with two or more fingers

selecting the UI of many categories of Earth, Mars, Jupiter, Venus, etc., like the solar system

arranging and previously providing the UI according to use patterns by recording and updating patterns of all users of using the programs that have been used by the users according to time of day, days of a week, special dates of one month, and special months of one year

displaying icons while rotating the spherical UI at constant speed (or irregular speed or preset speed). In this case, the icons show the content or states of a current program. Alternatively, the icons may show only the currently running applications.

As such, according to the embodiment of the present invention, icons on the main screen are displayed in the form of a user-centered 3D UX-UI based on a user preference of applications, thereby improving convenience and accessibility to an application that a user prefers or frequently uses.

The embodiments of the present invention may be realized in the form of program instructions which can be implemented through various computer components, and may be recorded in a computer-readable storage medium. The computer-readable storage medium may include a program instruction, a local data file, a local data structure, and the like either alone or in combination thereof. The program instruction recorded in the computer-readable storage medium may be any program instruction particularly designed and structured for the present invention or known to those skilled in the field of computer software. Examples of the computer-readable storage medium include magnetic recording media such as hard disks, floppy disks and magnetic tapes, optical data storage media such as CD-ROMs or DVD-ROMs, magneto-optical media such as floptical disks, and hardware devices, such as read-only memory (ROM), random-access memory (RAM), and flash memory, which are particularly structured to store and implement the program instruction. Examples of the program instruction include not only machine language code formatted by a compiler but also high level language code which can be executed by a computer using an interpreter.

Although some embodiments have been described herein, it should be understood by those skilled in the art that these embodiments are given by way of illustration only, and that various modifications, variations, and alterations can be made without departing from the spirit and scope of the present invention. Accordingly, the scope of the present invention should be limited only by the accompanying claims and equivalents thereof.

What is claimed is:

1. An apparatus for user-centered icon layout on a main screen, comprising:
a generator which analyzes a usage pattern of a user terminal according to applications and generates lifestyle information based on a user preference of the applications;
a determiner which determines order of priority with regard to the applications according to usage frequency and duration for each of the applications installed in the user terminal based on the lifestyle information; and
a display which selects N applications (where, N is a natural number) based on the determined order of priority with regard to the applications, loads icons respectively corresponding to the N selected applications from a memory, and displays the icons on the main screen of the user terminal.

2. The apparatus according to claim 1, further comprising:
an application recommender which records and updates a use pattern of an application used more frequently than a preset number of times for a preset duration by operation of the icons displayed on the main screen, determines a recommendation index of an application based on the updated result, and makes a recommendation list of applications based on the recommendation index,
wherein the display displays the recommendation list on the main screen of the user terminal.

3. The apparatus according to claim 1, further comprising:
a schedule recommender generating an update package in which a user's life pattern is reflected through analysis of the lifestyle information, and recommending a schedule related to use of an application based on the generated update package.

4. The apparatus according to claim 3, wherein the schedule recommender estimates a current prediction issue based on news, newspapers, or issues in the same time of day as that of the past related to weather, and recommends the schedule based on the prediction issue.

5. The apparatus according to claim 1, wherein the display arranges N icons loaded from the memory in the form of a three-dimensional (3D) sphere consisting of plural folds of transparent layers, and displays the icons as an integrated user interface (UI) on the main screen of the user terminal.

6. The apparatus according to claim 5, wherein the display displays the N icons on the main screen of the user terminal such that icons of the respective layers are sequentially exposed to a superficial layer of the main screen according to schedules of applications determined corresponding to months, dates, days of a week, and time of day, the exposed icon being displayed again on the integrated UI at the next schedule after the exposed icon disappears from the integrated UI.

7. A method for user-centered icon layout on a main screen, comprising:
by a generator of an apparatus for user-centered icon layout on the main screen, analyzing a usage pattern of a user terminal according to applications, and generating lifestyle information based on a user preference of the applications;
by a determiner of the apparatus for user-centered icon layout, determining order of priority with regard to the applications according to usage frequency and duration for each of the applications installed in the user terminal based on the generated lifestyle information; and
by a display of the apparatus for user-centered icon layout, selecting N applications (where, N is a natural number) based on the determined order of priority with regard to the applications, loading icons respectively corresponding to the N selected applications from a memory, and displaying the icons on the main screen of the user terminal.

8. The method according to claim 7, further comprising:
by an application recommender of the apparatus for user-centered icon layout, recording and updating a use pattern of an application used more frequently than a preset number of times for a preset duration by operation of the icons displayed on the main screen of the user terminal;
by the application recommender of the apparatus for user-centered icon layout, determining a recommendation index of an application based on the updated result;
by the application recommender of the apparatus for user-centered icon layout, making a recommendation list of applications based on the determined recommendation index; and
by the display of the apparatus for user-centered icon layout, displaying the recommendation list on the main screen of the user terminal.

9. The method according to claim 7, further comprising: by a schedule recommender of the apparatus for user-centered icon layout,
generating an update package in which a user's life pattern is reflected through analysis of the lifestyle information; and
recommending a schedule related to use of an application based on the generated update package.

10. The method according to claim 9, further comprising:
by the schedule recommender of the apparatus for user-centered icon layout, estimating a current prediction issue based on news, newspapers, or issues in the same time of day as that of the past related to weather; and
by the schedule recommender of the apparatus for user-centered icon layout, recommending the schedule based on the prediction issue.

11. The method according to claim 7, further comprising:
by the display of the apparatus for user-centered icon layout, arranging N icons loaded from the memory in the form of a three-dimensional (3D) sphere consisting of plural folds of transparent layers, and displaying the icons as an integrated user interface (UI) on the main screen of the user terminal.

12. The method according to claim 11, further comprising:
by the display of the apparatus for user-centered icon layout, displaying the N icons on the main screen of the user terminal such that icons of respective layers are sequentially exposed to a superficial layer of the main screen according to schedules of applications determined corresponding to months, dates, days of a week, and time of day, the exposed icon being displayed again in the integrated UI at the next schedule after the exposed icon disappears from the integrated UI.
